(19) United States
(12) Patent Application Publication
(10) Pub. No.: US 2013/0061455 A1
(43) Pub. Date: Mar. 14, 2013

(54) Bio-reactor for the production of bio-fuel from algae

(71) Applicant: Brian William Greene, Roslindale, MA (US)

(72) Inventor: Brian William Greene, Roslindale, MA (US)

(21) Appl. No.: 13/229,028

(22) Filed: Sep. 9, 2011

(51) Int. Cl. B23P 17/00

(52) U.S. Cl. 29/592

(57) ABSTRACT

The present embodiment provides an algae bioreactor comprising a coaxial configuration for the optimal dispersion of light and gas.

### BACKGROUND OF INVENTION

Early experiments in the intentional cultivation of algae began in 1957 for the cultivation of animal feed. In one experiment, the mono cellular Chlorela were cultivated by adding CO2 and some minerals. Early bioreactors were made of glass and later systems moved to transparent plastic.

A common method of harvesting algae utilizes ponds in which algae are grown and, during summer months, harvested on a daily basis. It is generally accepted that light only penetrates the first inch and a half of water in a manner sufficient to grow algae. Common production quantities per acre of this type of algae farm are approximately 3000 gallons of oil per acre (43,560 ft²). The working volume is approximately 5445 ft³, resulting in about 0.55 gallons of oil produced per cubic foot of working space per year.

Tubular algae bio-reactors consist of a vertical or horizontal arrangement of tubes with algae suspended in fluid and circulated throughout the system. The introduction of gas at either the beginning or the end of the system is commonly performed to accelerate algae growth, and generally leaves a lack of gas at the opposite end of the circulatory system therein. A system with even introduction of gas and light would improve the current state of the art.

### SUMMARY OF THE INVENTION

It is important to note, that in an enclosed greenhouse facility where the temperature and light conditions can be monitored and regulated productivity can be expected to increase, as compared to the above method using only naturally occurring weather conditions.

The present embodiment uses coaxial tubing to keep the maximum distance of the growth medium for the algae at the optimum 1.5-inch distance from the light source. Assuming a light source diameter of 0.5 inches, this makes the outer tube diameter 3.5 inches, for example, though the embodiment is not limited to these dimensions. Each assembly consists of multiple coaxial units in order to provide easy and cost efficient maintenance.

US Patent Application 20090215155 refers to a trough lining assembly placed in a series of troughs at a biomass processing facility. The trough lining assembly includes a waterproof liner that lies against the sides of a trough, an aerator, and a retention mechanism that retains the aerator at the bottom of the trough.

U.S. Patent 60/602,703 discloses a photobioreactor for cultivating a photosynthetic organism. The photobioreactor has a container for containing a liquid culture medium for cultivating photosynthetic organisms, light-emitting tubes mounted within the container.

Some inventions involve devices that provide an apparatus for cultivating algae in tubular structures. None of the prior art offers a coaxial configuration for the optimal dispersion of light and gas.

### BRIEF DESCRIPTION OF THE DRAWINGS

FIG. 1 is a front perspective view of the embodiment

FIG. 2 is a rear perspective view of the embodiment

FIG. 3 is a cut-away view of the embodiment

FIG. 4 is a view of an iteration of the embodiment

FIG. 5 is a rear view of an iteration of the embodiment

FIG. 6 is a cut-away view of the embodiment

FIG. 7 is an exploded view of an iteration of the embodiment

FIG. 8 is a cut-away view of an iteration of the embodiment

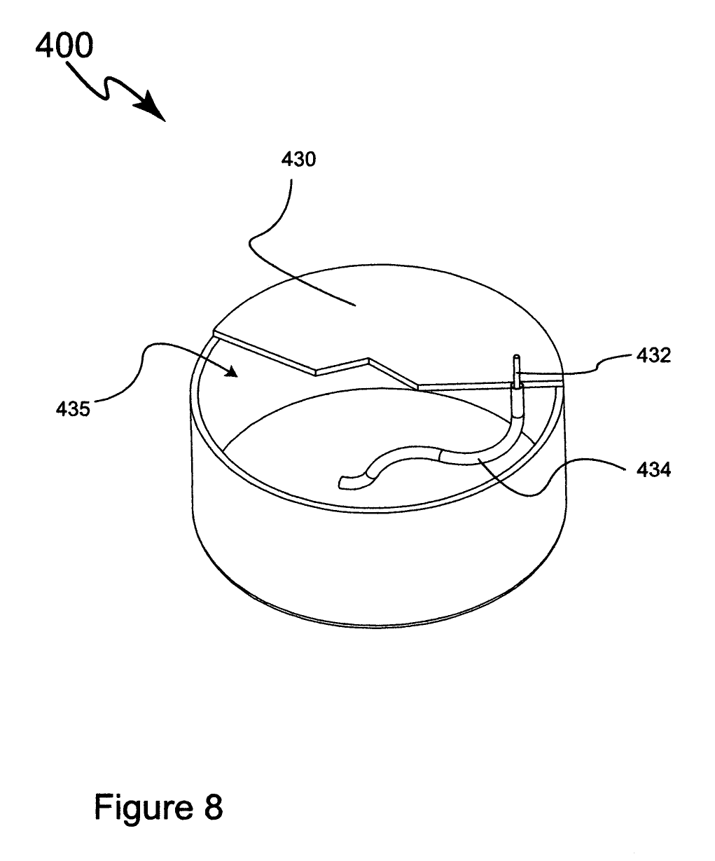

### DETAILED DESCRIPTION OF DRAWINGS

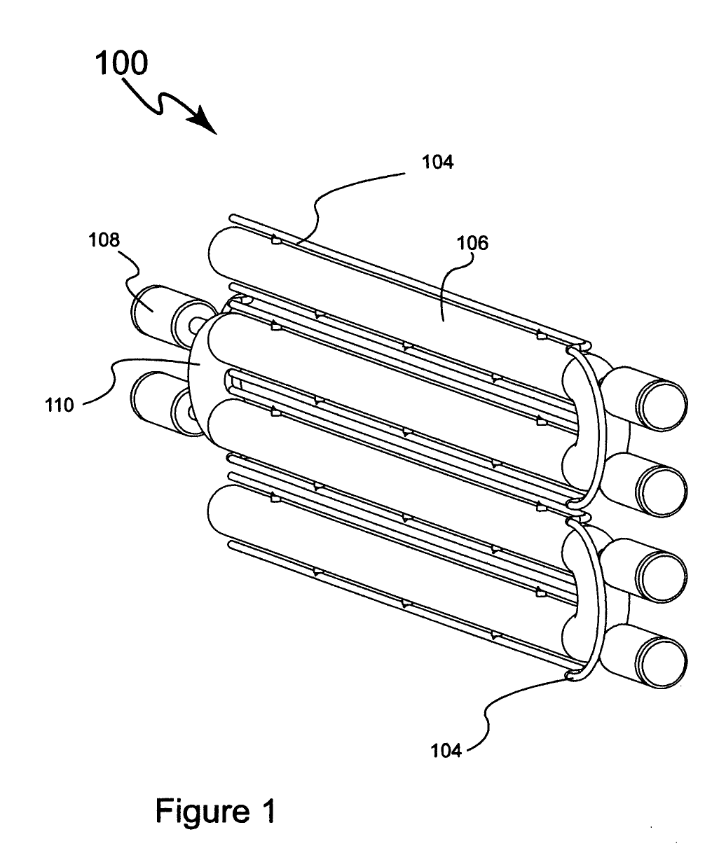

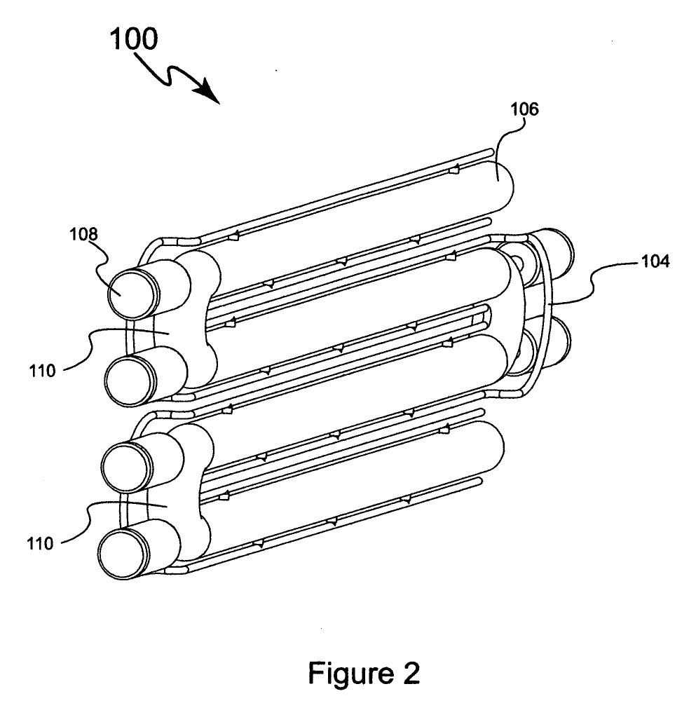

The depiction if FIG. 1 shows perspective view of the embodiment. The embodiment is configured as a modular unit and any number of modules may be engaged to provide a scalable bioreactor. The module is comprised of linear conduit 106, that is engaged with elbow conduit 110. Gas injector conduit 104 is engaged with and is in intermittent fluid communication with linear conduit 106 and/or elbow conduit 110. Light housings 108 are engaged with the elbow 110 and linear conduit 106 (FIG. 1 and FIG. 2).

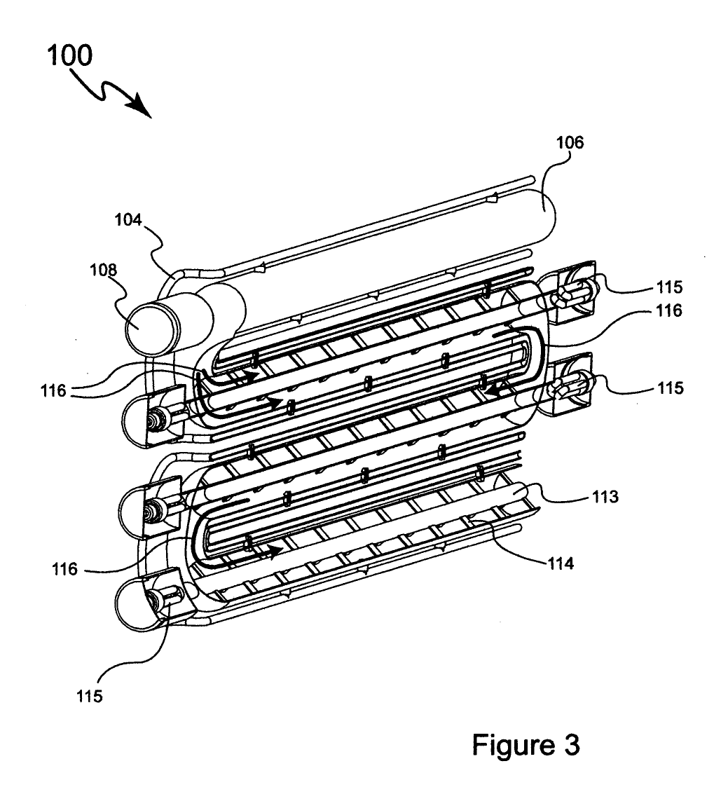

The depiction in FIG. 3 shows a cut-away view of the embodiment.

Algae in solution flows through linear conduit 106, and elbow conduit 110, along the flow path described by arrows 116. Light emitters 115 are comprised of point source illumination devices and/or linear light transmission devices. Point source devices include light bulbs, light emitting diodes (LEDs) and the like. Linear light transmission devices include LED series lighting, fiber optic cable and the like. The light is transmitted along the coaxial light tubes 113 and diffused through the algae in solution. Reflective surfaces along the interior surfaces of the linear conduit 106 and elbow conduit 108 allow the light to be reflected back into said algae in solution. Light housings 108 are engaged with and support members 114 that are engaged with light transmission tubes 113 and with linear conduit 106 and/or with elbow conduit 110. Light housings 108 illuminate light transmission tubes 113 and transmit light through linear conduit 106.

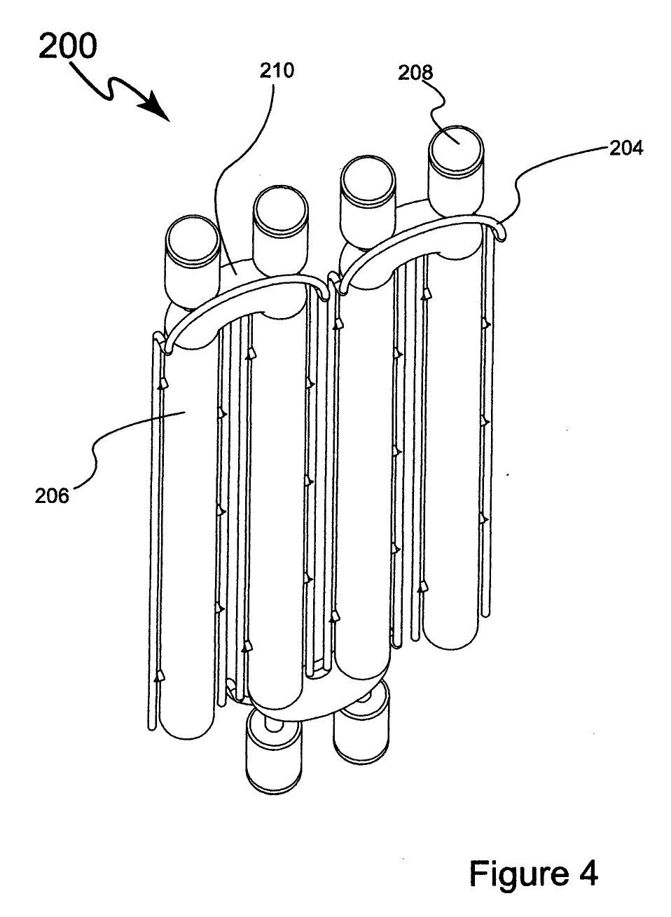

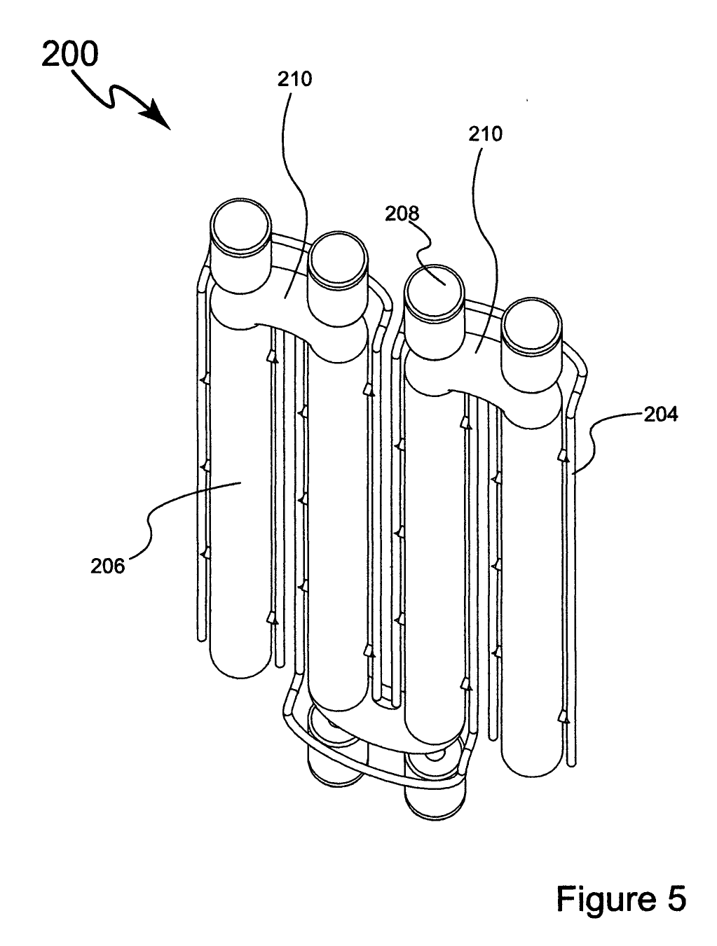

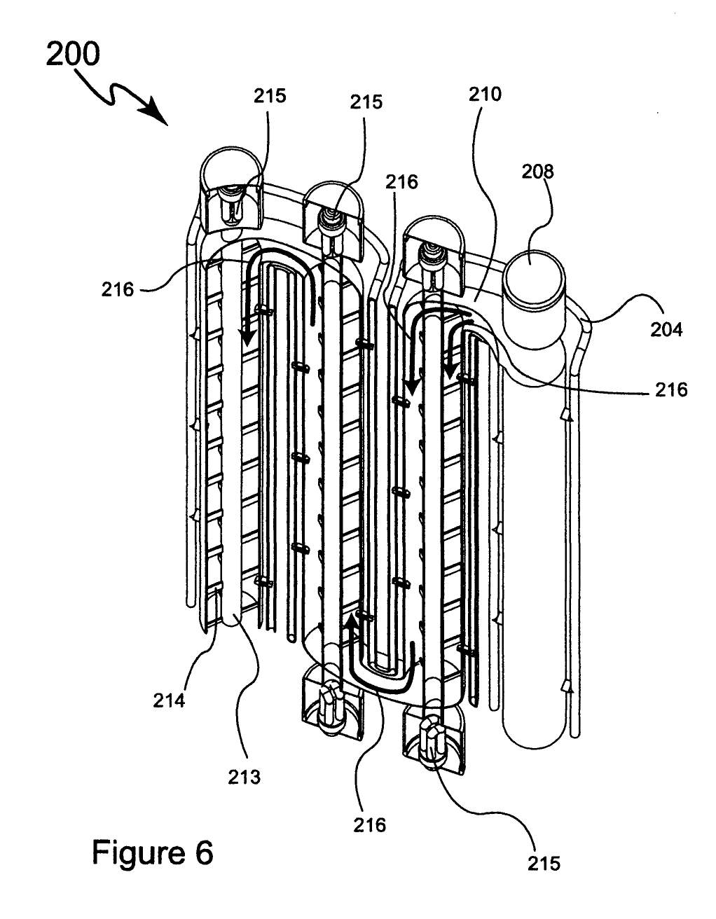

The illustrations in FIG. 4, FIG. 5 and FIG. 6 show an iteration of the embodiment 200 in which the aforementioned components are oriented in a vertical configuration.

The module is comprised of vertical conduit 206, engaged with elbow conduit 210. Gas injector conduit 204 is engaged with and is in intermittent fluid communication with vertical conduit 206 and/or elbow conduit 210. Light housings 208 are engaged with the elbow 210 and vertical conduit 206 (FIG. 4 and FIG. 5).

The depiction in FIG. 6 shows a cut-away view of the iteration of the embodiment. Algae in solution flows through vertical conduit 206, and elbow conduit 210, along the flow path described by arrows 216. Light emitters 215 are comprised of point source illumination devices and/or vertical light transmission devices. Point source devices include light bulbs, light emitting diodes (LEDs) and the like. Vertical light transmission devices include LED series lighting, fiber optic cable and the like. The light is transmitted along the coaxial light tubes 213 and diffused through the algae in solution. Reflective surfaces along the interior surfaces of the vertical conduit 206 and elbow conduit 208 allow the light to be reflected back into said algae in solution. Light housings 208 are engaged with and support members 214 that are engaged with light transmission tubes 213 and with vertical conduit 206 and/or with elbow conduit 210. Light housings 208 illuminate light transmission tubes 213 and transmit light through vertical conduit 206.

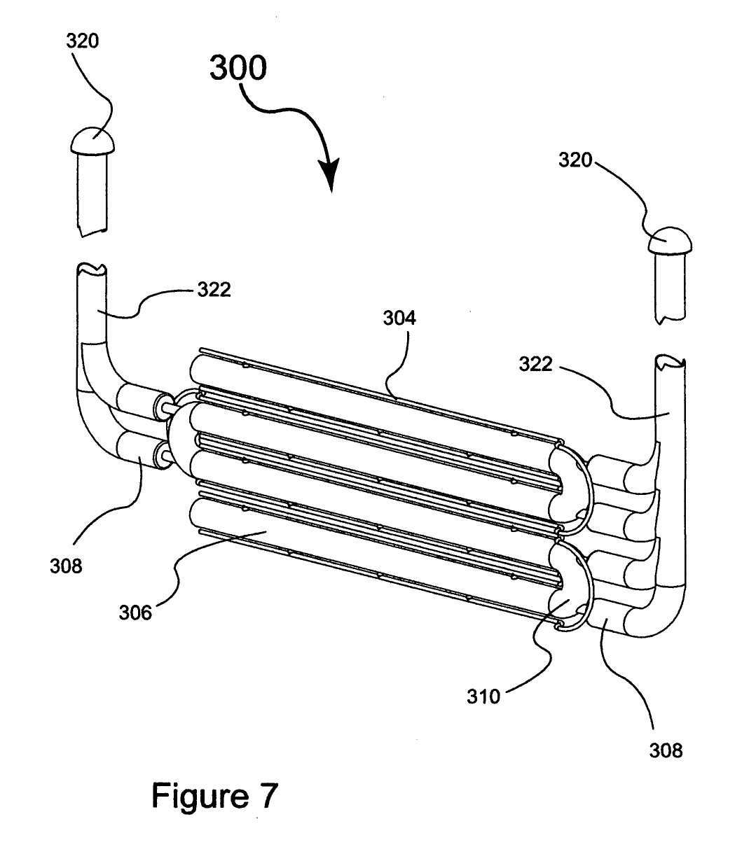

Another iteration of the embodiment 300 is illustrated in FIG. 7. Solar collectors are used in combination with light transmission tubes 322 to transmit sunlight into coaxial light tubes.

Algae in solution flows through conduit 306, and elbow conduit 310, along a similar flow path as previously described. Solar collectors 320 are comprised of lens and reflector combinations that are common in the prior art and not invented here. Light tubes 322, also common, transmit light to tubes 306 and elbows 310. The light is transmitted along the light tubes 322 and diffused through the conduit 306 and the algae in solution along coaxial light tubes 313. Reflective surfaces along the interior surfaces of the conduit 306 and elbow conduit 310 allow the light to be reflected back into said algae in solution.

Another iteration of the embodiment 400 comprises a fluid transmission tube 434 in co-axial engagement with light transmission tube 432 in combination are inserted into fluid holding tank 430. Fluid is pumped from the fluid storage area 435, through the fluid transmission tube 434 and back into the fluid storage area 435. Fluid under pressure in a flexible tube such as fluid transmission tube 434 will move in a random pattern throughout the fluid storage area 435. The light transmission tube 432 that is in co-axial engagement with the fluid transmission tube 434 moves randomly through the fluid, thus moving algae in a random pattern through the holding tank 430.

We claim:

1. A method of construction for an algae bioreactor comprising a series of co-axial tubes that promote the transmission of light and gas through the one set of tubes and algae in solution through coaxial tubes thus providing an optimal depth of solution for light and gas penetration.
